(19) United States
(12) Patent Application Publication
(10) Pub. No.: US 2012/0222536 A1
(43) Pub. Date: Sep. 6, 2012

(54) MACHINE FOR DEPALLETISING A MULTI-LAYER LOAD

(75) Inventor: Marino Sain, Roveredo in Piano (IT)

(73) Assignee: BORTOLIN KEMO S.P.A., 33080 Porcia (Pordenone) (IT)

(21) Appl. No.: 13/508,291

(22) PCT Filed: Oct. 8, 2010
(86) PCT No.: PCT/IB2010/054553

§ 371 Date: May 4, 2012

(30) Foreign Application Priority Data
Nov. 12, 2009 (IT) MO2009A000272

(51) Int. Cl. B26D 5/00

(52) U.S. Cl. 83/743

(57) ABSTRACT

A machine for depalletising a multi-layer load (C) comprises a first station (100) for unstacking a multi-layer load (C) wrapped in a packing film (P), which first station (100) comprises an area (101) for housing a multi-layer load (C) enveloped in a wrapping film (P), a guide (102) arranged about the area (101) and at least partly surrounding the load (C) arranged in the area (101), a carriage (103) mobile along the guide (102) and supporting a circular blade (107) for realising a horizontal cut in the packing film (P) of the load (C). The carriage (103) further supports an electric motor (108) destined to activate the circular blade (107), and a rechargeable battery (113) for supplying the electric motor (108).

### TECHNICAL FIELD

The invention relates to a machine for depalletising a multi-layer load. In particular the invention relates to a machine for unstacking a multi-layer pallet of articles (for example containers such as glass or plastic bottles) initially enveloped by a protective packaging film.

Further, the machine of the invention is preferably also suitable for the subsequent removal operation of the portion of protective film which envelops the unstacked layers.

### BACKGROUND ART

The above-mentioned multi-layer pallets comprise a succession of flat superposed layers of articles, separated from one another by separator sheets (in the form of sheets of plastic or pressed cardboard) and externally enveloped by a packaging film which packages the whole load, possibly with a lower support pallet. The topmost layer is superiorly covered by a top, generally in the form of an upturned cardboard tray, which serves in particular to prevent damage to the protective film and to stabilise the load when it is not enveloped in film.

Before using the articles, for example in a packaging line, the pallet must be freed of covering, i.e. the packaging film and the top cover have to be removed, and the pallet then has to be depalletised, i.e. the various layers of the pallet, freed of the separating sheet, have to be transferred one by one towards the zones of use.

A machine for realising the above-cited depalletising steps is described in patent EP 1521707 in the name of the present applicant.

The above machine comprises a cutting tool mounted on a carriage which is slidably borne by a closed guide developing peripherally about the load to be depalletised. The cutting tool is constituted by a knife exhibiting a cutting edge in the advancement direction of the carriage and is destined to interfere with the wrapping film of the load such that an advancement of the carriage along the guide determines a progressive cutting of the wrapping film in proximity of a separating sheet (in particular the sheet o associated to the topmost layer).

When the tool has completed an entire tour around the load, the topmost layer can be removed, by means of known systems, together with the separating sheet and the annular strip of wrapping film which still retains the articles of the layer together.

Thereafter, the layer thus removed is taken to a station in which the above-cited annular strip of wrapping film is cut and manually removed by an operator, who takes it to a collection container. The articles can then be sent on to a conveyor belt for inlet to a respective work line (for example the above-mentioned packaging line).

The applicant has noted that the machine as above-described is disadvantageously affected by some drawbacks.

The cutting tool often tends to snag in the wrapping film during the cutting operation, and this leads to a halting in the correct cutting action which, as the carriage advances, leads to unforeseen lacerations in the film.

The unexpected laceration in the wrapping film often leads to a tipping-over of the articles, or even to their falling, with consequent breakage or damage to the articles themselves.

Further, the manual removal of the annular strips of film from the already-removed layers is often inadequate in the light of production rate and safety standards, as it requires the stationing of at least an operator in the immediate vicinity of the depalletising machinery.

In this context, the technical task underlying the present invention is to provide a machine for depalletising a multi-layer load which obviates the drawbacks in the prior art as mentioned above.

In particular, the aim of the present invention is to make available a machine for depalletising a multi-layer load which enables an effective and reliable cutting of the protective film of the load.

A further aim of the present invention is to provide a machine for depalletising a multi-layer load which provides high production rates.

A further aim of the present invention is to provide a machine for depalletising a multi-layer load which provides a high degree of safety.

The set technical objective and the specified aims are substantially attained by a machine for depalletising a multi-layer load comprising the technical characteristics set out in one or more of the accompanying claims.

### DISCLOSURE OF INVENTION

Further characteristics and advantages of the present invention will better emerge from the non-limiting description that follows of a preferred though not exclusive embodiment of a machine for depalletising a multi-layer load, as illustrated in the accompanying figures of the drawings, in which:

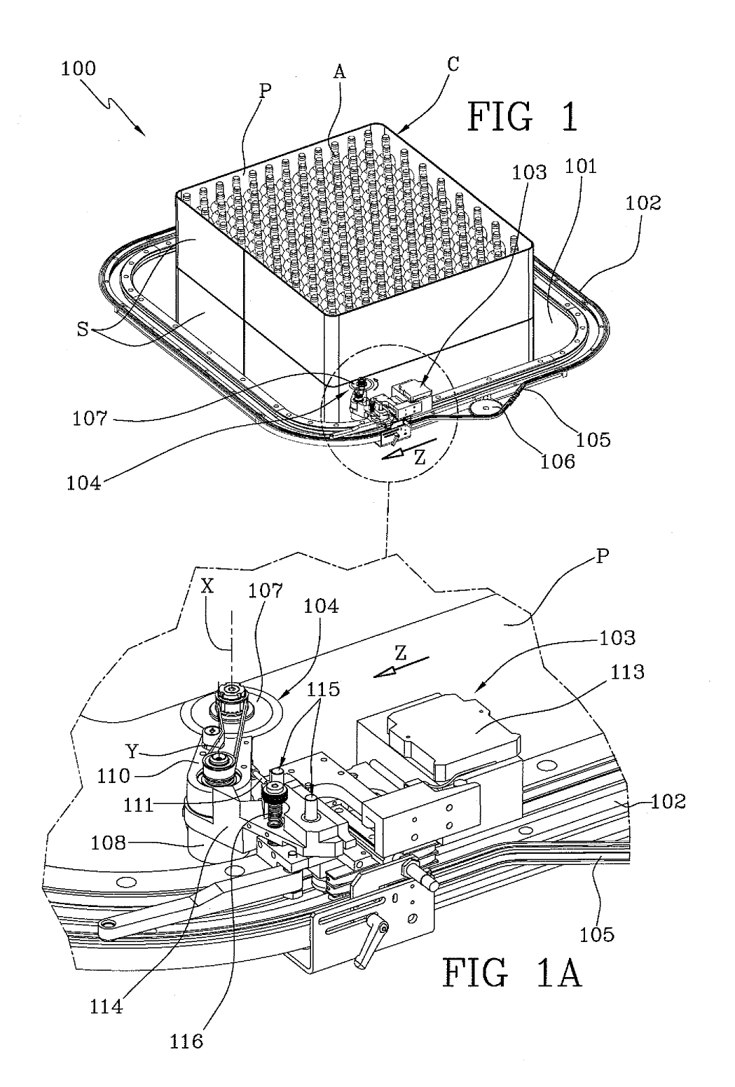

FIG. 1 is a perspective view of a first part of a machine for depalletising a multi-layer load of the present invention, with some parts removed better to evidence others;

FIG. 1A is an enlarged view of a detail of FIG. 1;

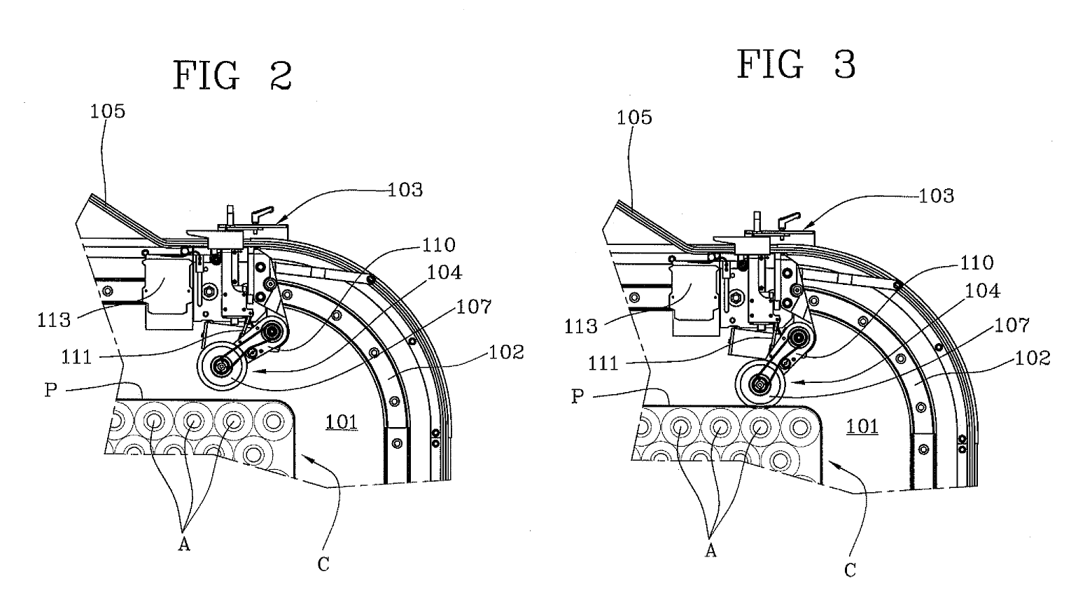

FIGS. 2 and 3 are two larger-scale plan views of a further detail of the part of the machine of FIG. 1 in two different operating configurations;

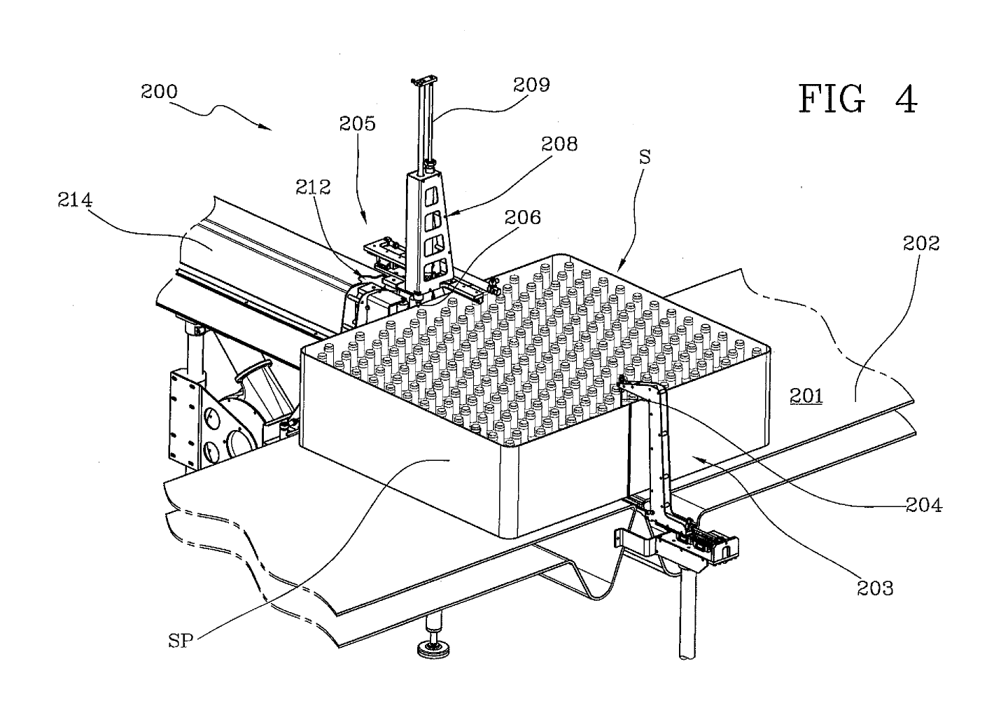

FIG. 4 is a perspective view of a second part of a machine for depalletising a multi-layer load of the present invention;

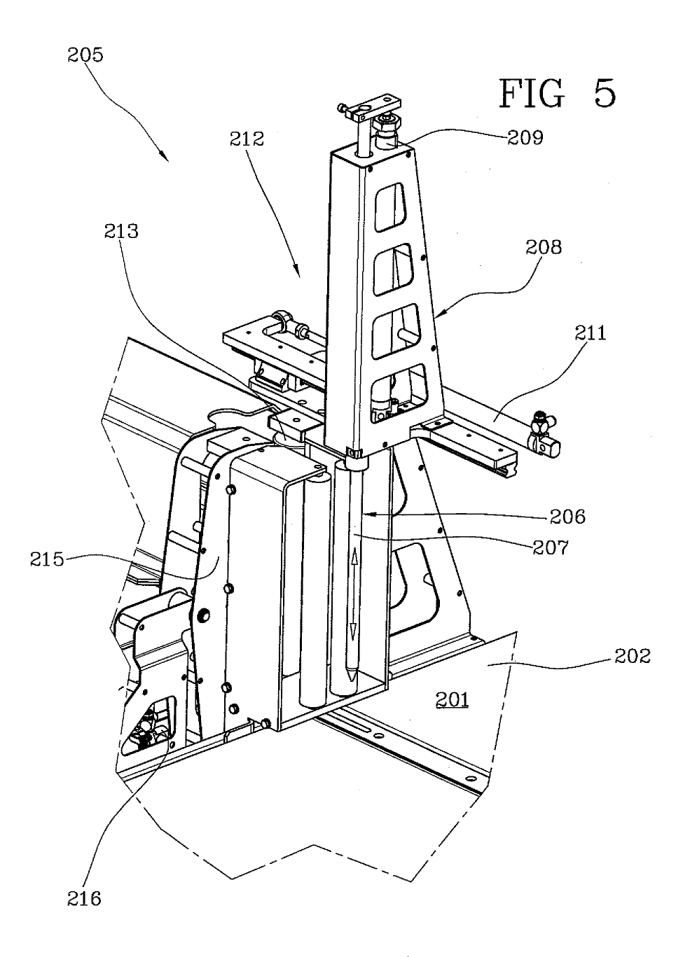

FIGS. 5-7 are larger-scale perspective views of the portion of the machine of FIG. 4, with some parts removed better to evidence others and in accordance with a succession of consecutive operating stages;

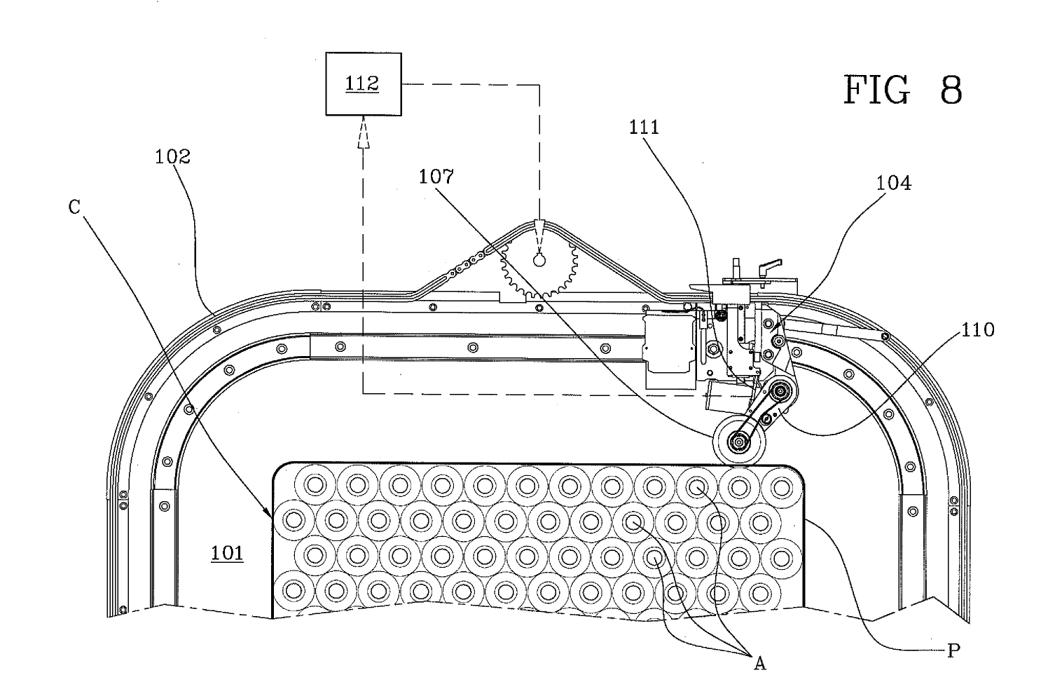

FIG. 8 is a schematic representation of a control system present in the machine of the invention;

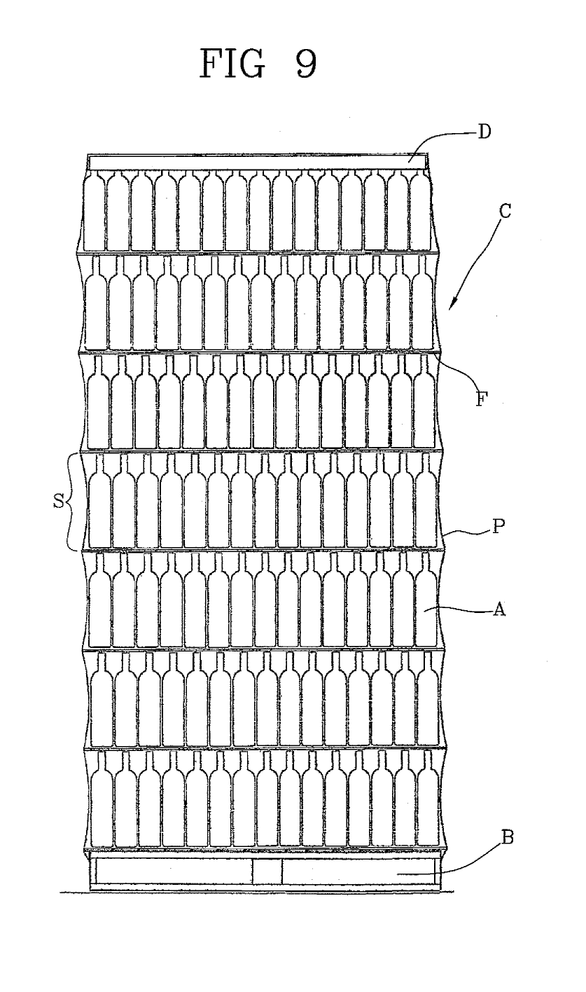

FIG. 9 is a front view of a palletised multi-layer load of a type suitable for being depalletised with the machine of the present invention.

The machine of the present invention is particularly, though not exclusively, useful for depalletising a multi-layer load C of the type illustrated in FIG. 9.

By the expression “multi-layer load” is intended a load C (FIG. 9) defined by a plurality of articles A (for example bottles or flagons) arranged on is layers S superposed on one another, separated by separating sheets F (in the form of cellular plastic or pressed cardboard or the like) and externally enveloped by a wrapping film P made of a heat-retractable or extensible material which packs the whole load C, possible with a bench or lower support pallet B. The topmost layer S of the load C can be superiorly covered by a top cover D, generally in the form of an upturned tray made of cardboard, which serves in particular to prevent damage to the protective wrapping film P at the top of the load C and to stabilise the load C when the load C is without wrapping film P.

Though in the illustrated embodiment all the layers are constituted by bottles, different types of articles could constitute the various layers, while remaining within the ambit of the present invention.

The machine substantially comprises a first station 100 for de-stacking the multilayer load C, i.e. for dividing the load C into a succession of layers S independent of one another. The first station 100 performs the cutting of the wrapping film P with the aim of enabling, time by time, removal of the layer S which is at the top of the load C, such as to be able to remove the whole layer S constituted by the articles A of the layer S and the respective separating sheet F (preferably the lower one).

Further, each layer S removed preferably exhibits, at least laterally, a strip of wrapping film, which takes on a closed and substantially annular conformation able to retain the articles A of the layer S up until a following removal stage of the wrapping film.

This removal happens in particular in a second station 200 dedicated to cutting and separating the strip of wrapping film, such as to be able to remove the articles A and send them, at this point separately of one another, to a successive work unit (for example a filling unit, a labelling unit or a packing unit).

There now follows a description of the first station 100 for de-stacking the various layers S of the load C, in accordance with FIGS. 1-3.

The first station 100 exhibits a first housing area 101 for the multi-layer load C to which the multi-layer load C (preferably palletised) is taken by known transfer means (not illustrated). The load is externally enveloped by the wrapping film P.

The multi-layer load C can be taken to the first housing area 101, for example though not exclusively, by a conveyor belt.

The machine further comprises a substantially horizontal guide arranged about the first housing area 101 for at least partially surrounding the load C arranged therein.

The guide 102 preferably develops along a ring-closed trajectory, which surrounds the first housing area 101 and thus the load C contained therein.

The guide 102 exhibits various straight tracts or sides, preferably four in number arranged reciprocally at right-angles, each parallel to a respective surface of a parallelepiped multi-layer load C, which sides are joined by curved connecting tracts in order to realise the above-cited ring-closed trajectory.

A carriage 103 is slidable along the guide 102 on command. The carriage 103 could be another mobile support organ bearing a cutting organ 104 predisposed to cut the wrapping film P in at least a cutting line that is substantially closed and horizontal and develops by 360° about the load C. The carriage 103 which bears the cutting organ 104 is activated to slide along the guide 102 by means of a flexible organ 105 (for example a cogged chain or belt) drawn by a drawing pulley 106. It is however possible for the carriage 103 to be of another type of movement means of known type.

The guide 102 is preferably borne by a mobile support (not illustrated) which is susceptible to displacement in a vertical direction, in both senses, for positioning the cutting organ 104 at a desired height in the cited first housing station 101. The mobile support is preferably of the type described in patent EP 1521707 (in the name of the present applicant), which is referred-to herein for reasons of complete reference relating to the part describing the mobile support of the horizontal guide.

The cutting organ 104 preferably comprises a circular blade 107, rotating about a rotation axis X that is substantially vertical and connected to a respective electric motor 108, also mounted on the carriage 103. The circular blade 107 is connected to the electric motor 108 by means of a relative transmission 109, for example a belt transmission.

The circular blade 107 is preferably provided with a nearing and distancing movement with respect to the first housing area 101, and thus with respect to the multi-layer load C arranged therein, between an engaged position with the load C (FIG. 3), in which it realises the cutting of the wrapping film P and a disengaged position (FIG. 2) in which it is distanced from the load C. In the engaged position, the circular blade 107 places a cutting portion thereof in contact with the wrapping film P of the load C, while in the disengaged position the circular blade 107 is retracted, distanced from the load C and thus does not perform any cutting action.

The circular blade 107 is associated to a support arm 110 which, in turn, is supported by a connecting component 114. The connecting component 114 is associated to the carriage 103 by means of a vertical guide 115 provided with elastic means 116. The function of the vertical guide 115 and the elastic means 116 is evident from the following.

The circular blade 107 is preferably positioned, at the start of the cutting operation, above the edge of the separating sheet F, resting on the sheet F itself. The circular blade 107 can perform, with respect to the carriage 103, a vertical compensating movement along the vertical guide 115 following the action of elastic means 116 which act such as to press the blade downwards to enable the blade, during the cutting of the film, to rest more or less continuously on the edge of the sheet F, even when the sheet F is corrugated or in any case not perfectly flat. Alternatively the circular blade 107 can be positioned at the start of cutting, below the edge of the sheet F. In this case the elastic means 116 are conformed such as to push the circular blade 107 upwards.

It is further preferable for the circular blade 107 to exhibit, either below or above the cutting edge, an inclined surface such as to prevent, on the one hand, the articles A from getting cut and, on the other hand, the separating sheet also from getting cut.

In a case in which the articles are constituted by bottles or vials, in order to guarantee correct cutting of the wrapping film P, the circular blade 107 is inserted slightly below the containers, at the rounded part of the edge of the rest base thereof.

As previously described, the circular blade 107 realises a nearing and distancing movement with respect to the load C. This nearing and distancing movement is realised by means of the support arm 110, which is hinged at a first end thereof to the connecting component 114 and, at the other end, supports the circular blade 107. The support arm 110 is rotatable about the carriage by tilting about a substantially vertical axis Y and, preferably, parallel to the rotation axis X of the circular blade 107. Elastic contrast means (not visible in the figures of the drawings) are operatively interposed between the carriage 103 and the support arm 110, which elastic contrast means have the function of impressing an elastic thrust of a predetermined entity on the support arm 110 in a nearing direction to the load, and thus in a distancing movement from the carriage 103.

The support arm 110 is preferably arranged, starting from the connecting hinge to the carriage 103, in an opposite direction with respect to an operating advancement direction Z of the carriage 103. Thus, should the circular blade 107 encounter an obstacle to cutting (for example a lump of plastic material, an extraneous body or a simple snagging of the blade on the plastic film) the greater resistance offered by the plastic film P on the circular blade 107 would generate a tilting of the support arm 110 such as to distance the circular blade 107 from the load C and, consequently, a nearing of the circular blade 107 to the carriage 103.

Advantageously, a sensor 111 is active between the support arm 104 and the carriage 103, preferably a linear or angular sensor, designed to generate an alarm signal should the angle formed between the support arm 110 and the carriage 103 fall below a predetermined value. Assuming that a greater resistance to the circular blade's 107 cutting action corresponds to a greater tilting of the support arm 110 towards the carriage 103, the reaching of the predetermined value of the angle represents the reaching of a predetermined value of resistance encountered by the circular blade 107. As can be seen in FIG. 8, the alarm signal generated by the sensor 111, representing the spatial orientation of the support arm 110 with respect to the carriage 103, is sent to a control panel 112 which in the presence of the alarm signal immediately halts the carriage 103. The halting of the carriage 103 is preferably realised by blocking the rotation of the drawing pulley 106, for example interrupting the supply to respective motor means of the drawing pulley 106 and/or braking the rotation of the pulley 106 itself.

In an alternative solution, the sensor 111 generates a continuous signal representing the spatial orientation (preferably angular) of the support arm 110 with respect to the carriage 103 and transmits it to the control panel 112, which interrupts the advance of the carriage 103 along the guide 102 when the signal indicates that the spatial orientation has passed beyond a predetermined threshold.

The communication of the signal between the sensor 111 and the control panel 112 is via a wireless connection.

Summarising the above, it can be said that the elastic contract means exhibit an appropriate yielding property the function of which is to enable a backwards tilting of the support arm 110, easily monitorable such as to enable the detection of obstacles to the cutting of the wrapping film P on the part of the circular blade 107.

The electric motor 108 activating the circular blade 107 is advantageously powered by a battery 113 which is preferably rechargeable. In this way no dragging contacts are necessary, which would otherwise guarantee an electrical continuity between the electric motor 108, mounted on the carriage 103, and a fixed electricity supply.

In a further advantageous aspect, the first station 100 exhibits a charging station (not illustrated) arranged preferably along the guide 102 and destined to interact with the carriage 103, for recharging the battery 113, at least when the carriage 103 is at a predetermined position along the guide 102.

The recharging station is preferably arranged at a rest station, in which the carriage 103 is parked when the circular blade 107 is not operating (for example during positioning of a new multi-layer load C in the first housing area 101).

This interaction between the loading station and the carriage is preferably realised by means of dragging contacts (localised in a very limited sector of is the guide 102) which intervene only when the carriage 103 reaches the rest/reloading station.

Alternatively automatic connectors can be used which automatically or on command of a control unit or an operator activate at the moment at which the carriage 103 reaches the rest/reloading station.

In an alternative embodiment which is not illustrated, it is further possible to comprise the use of several cutting organs 104 which can operate simultaneously on the same horizontal plane, mobile on the same guide 102, or which can operate on different horizontal planes on distinct guides 102 either simultaneously or in sequence.

In this case, each cutting organ 104 is associable to a respective control system, in particular a respective sensor 111 connected to a respective control panel 102 or a control panel which is common to all the sensors.

FIGS. 4-7 illustrate the second removal station 200 of the closed annular strip of wrapping film P from a layer S separated previously from the multilayer load C.

The second station 200 exhibits a second area 201 for housing the layer S, preferably defined by a part of a horizontal rest surface 202 such as, for example, the upper branch of a horizontal belt conveyor.

The layer S is positioned in the second housing station 201 using known transfer systems which are not described herein.

The second station 200 comprises a cutting tool 203, mobile in nearing and to distancing directions with respect to the layer S in order to realise the cutting of the closed annular strip SP of wrapping film which at least laterally retains the articles A of the layer S.

For reasons of clarity in the illustration of the characteristics of the second station 200, the layer is not illustrated in FIGS. 5-7.

The cutting tool 203 realises a cut of the strip SP in a transversal direction, preferably perpendicular, with respect to the cutting direction previously realised by the circular blade 107. The cutting tool 203 of the second station 200 preferably performs a cut in a vertical direction, such as to bring the strip SP to take on an open conformation, having two opposite end flaps.

In a preferred embodiment, the cutting tool 203 of the second station 200 comprises a hot wire 204 oriented vertically and mobile in nearing and distancing directions to and from the strip SP.

On the opposite side of the load C with respect to the hot wire 204, the second station 200 comprises automated collecting means 205, active on the layer S such as to grip the opened strip SP and expel it from the second housing area 201.

In the illustrated embodiment of FIGS. 4-7, the automated collecting means 205 comprise:

a hooking element 206, destined to engage the second housing area 201 such as to insert internally of the external peripheral profile of the annular strip SP of wrapping film;

an expeller device 212, arranged externally of the second housing area 201 in order to intercept the strip SP of wrapping film and distance it from the second housing area 201, preferably by sending the strip SP to a collecting container (not illustrated).

In greater detail, the hooking element 206 comprises a pin 207 (or more generally an elongate element), preferably cylindrical, which is slidably supported in a vertical direction by a support structure 208.

The support structure 208 has the function of moving the pin 208 in a nearing and distancing direction to and from the rest surface 202 between a raised position (FIG. 4), in which the pin 207 is at a distance from the rest surface 202 that is sufficient to enable entry of a layer S of the load C onto the rest surface 202, and a lowered position (FIG. 5) in which it is arranged internally of the external peripheral profile of the strip SP which envelops the articles A of the layer S.

The vertical movement of the pin 207 is realised by means of a first linear actuator 209.

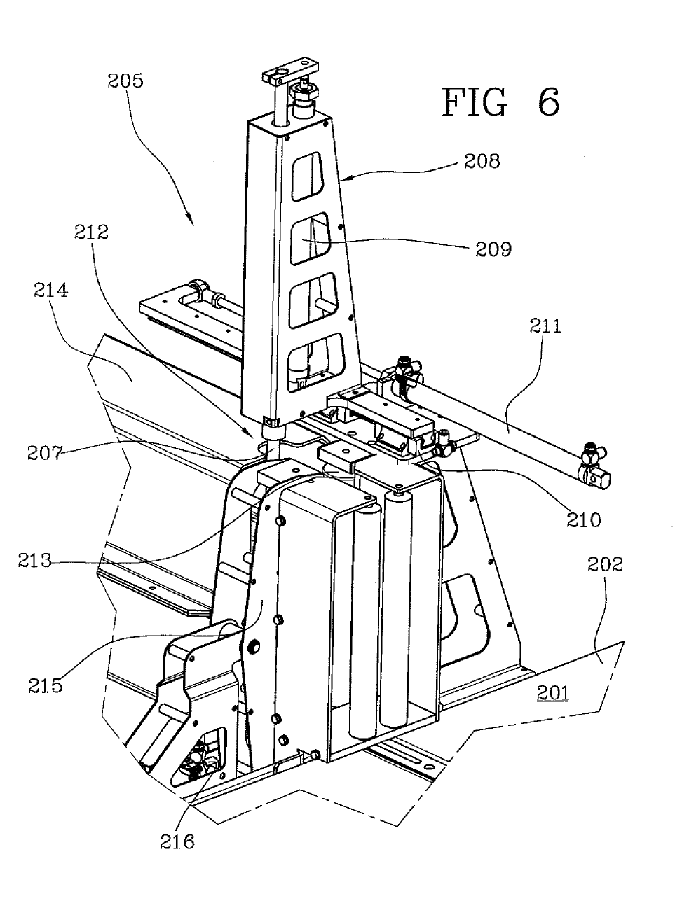

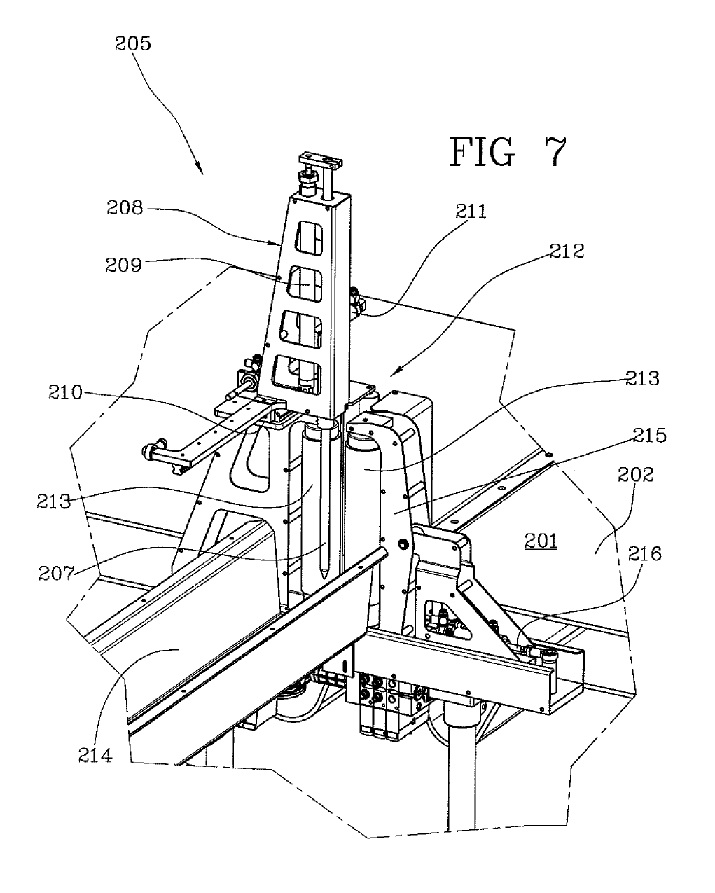

The pin 207 is further horizontally mobile between a first position (FIGS. 4 and 5), in which it is arranged in or above the second housing area 201 in order to be able to insert internally of the external peripheral profile of the strip SP, and a second position (FIGS. 6 and 7) in which it is arranged at the expeller device 212, such that in the passage between the first and second position the pin 207 intercepts a portion of the strip SP (previously opened by a cut performed by the hot wire 204) and draws it towards the expeller device 212.

The horizontal movement of the pin 207 between the first and the second position is achieved by means of a translation of the support structure 208 on respective guides 210 (visible in FIG. 6), operated by a second linear actuator 211.

With reference to the expeller device 212, it comprises at least a pair of rollers 213 rotatable about axes that are preferably parallel to the pin 207, i.e. vertical, the function of which is to receive the strip SP of wrapping film from the pin 207 and draw it away from the second housing area 201. In particular, the expeller device 212 can comprise a conveyor channel 214 adjacent to the rollers 213 in order to receive the strip SP of wrapping film from the rollers 213.

In greater detail, at least one of the two rollers 213 is mobile in a nearing and distancing direction with respect to the other roller, between a distanced position, suitable for passage of the pin 207 between the two rollers 213, and a neared position in which the rollers 213 are abutting and preferably pressing against one another in order to grasp a portion of the strip SP of wrapping film. The movement of the at least one or the two rollers 213 is achieved by means of mounting the roller 213 on a slide 215 which preferably slides in a perpendicular direction to the translation direction of the pin 207, moved by a third linear actuator 216.

At least one of the two rollers 213 is motorised to realise the automatic expulsion of the strip SP.

The above-described machine functions as follows.

A multi-layer load C is arranged in the first station 100, at the first housing area 101.

By moving about the load, following the advancement of the carriage 103 on the guide, the circular blade 107 makes a complete horizontal cut of the wrapping film P, separating the topmost layer S of the load C from the remaining part of the load S. The circular blade 107 might also perform, in succession, all the comprised cuts, descending vertically along the multilayer load C before performing the successive operations. Thereafter, the topmost layer S is transferred to the second station 200 and arranged at the second housing area 201.

Here the cutting of the closed strip SP enveloping the layer S is realised. At the same time as this step, or alternatively before or after this step, the pin 207 is arranged internally of the closed profile of the strip SP.

Once the cut of the strip SP has been performed by the hot wire, the pin 207 is retreated and while retreating intercepts a portion of the strip SP (now open) causing it to pass through the rollers 213.

The pin 207 thus is arranged in the second position thereof, beyond the rollers 213 (i.e. on the opposite side with respect to the second housing area 201). In this way, the rollers 213 can near one another, gripping the strip of wrapping film SP.

The pin can now raise and disengage from the strip, which is expelled by means of the rotation of the rollers 213.

The present invention attains the set aims and obviates the drawbacks noted in the prior art.

The use of a motorised circular blade realises an effective and reliable cut of the wrapping film, and reduces the risks of the blade's snagging, at the same time reducing the risk of unexpected lacerations of the film and any damage to the load.

Also, should snagging of the blade occur, or other events leading to an unexpected halt in the cutting operation, the special mechanism given by the support arm hinged to the carriage and the providing of a sensor retro-acting with the control panel enables the carriage to be halted safely before any damage to the load can occur.

Further, the energy supply to the blade motor is given by a battery mounted on the carriage, which deconstrains the carriage from any continuous-type connecting system to the electric mains grid. The machine is therefore more flexible and easier to install, as it requires no complex connections via cables or dragging contacts along the whole development of the guide.

1. A machine for depalletising a multi-layer load (C), comprising a first station (100) for unstacking a multi-layer load (C) wrapped in a packing film (P), the first station (100) comprising:
a first housing area (101) for a multi-layer load (C) enveloped in a wrapping film (P);
a guide (102) arranged about the first housing area (101) and at least partly surrounding the load (C) arranged in the first housing area (101);
a carriage (103) mobile along the guide (102);
a circular blade (107) mounted on the carriage (103) and facing towards the first housing area (101) for the load (C), for realising a cut in the packing film (P) of the load (C);
characterized in that it further comprises an electric motor (108), mounted on the carriage (103) and destined to activate the circular blade (107), and a battery (113), also mounted on the carriage (103) for supplying the electric motor (108).

2. The machine of claim 1, wherein the battery (113) is rechargeable and wherein the machine further comprises a recharging station, preferably arranged along the guide (102) and destined to interact electrically with the battery (113) in order to recharge the battery (113) at least when the carriage (103) is at a predetermined position along the guide (102).

3. The machine of claim 2, wherein the machine exhibits a rest station, preferably arranged along the guide (102) and in which the carriage (103) is arranged during non-operative stages of the circular blade (107), the recharging station coinciding with the rest station.

4. The machine of claim 1, comprising movement means (105, 106) of the carriage (103) along the guide (102) and at least a sensor (111) for detecting a resistant action acting on the circular blade (107) during the cutting of the packing (P); the machine further comprising a control panel (112) which acts at least on the movement means (105, 106) of the carriage (103) in order to halt advancing of the carriage (103) along the guide (102) when the resistant action detected by the sensor (111) exceeds a predetermined threshold.

5. The machine of claim 4, further comprising wireless communicating means between the sensor (111) and the control panel (112) in order to transmit a signal emitted by the sensor (111) to the control panel (112), which signal is preferably representative of the resistant action detected by the sensor (111).

6. The machine of claim 1, comprising: a support arm (100), hinged to a connection component (114) associated to the carriage (103), which supports at an end thereof the circular blade (107), the support arm (110) preferably facing oppositely to an operative advancement direction (Z) of the carriage (103) along the guide (102), and elastic thrust means, acting between the carriage (103) and the support arm (110) to distance the support arm (100) with respect to the carriage (103) such as to keep the circular blade (107) pressed towards the load (C).

7. The machine of claim 6, comprising movement means (105, 106) of the carriage (103) along the guide (102) and at least a sensor (111) for detecting a resistant action acting on the circular blade (107) during the cutting of the packing (P); the machine further comprising a control panel (112) which acts at least on the movement means (105, 106) of the carriage (103) in order to halt advancing of the carriage (103) along the guide (102) when the resistant action detected by the sensor (111) exceeds a predetermined threshold, and wherein the sensor (111) is destined to detect an angle of inclination between the support arm (110) and the carriage (103) and to send the signal to the control panel (112) when the angle falls below a predetermined threshold.

8. The machine of claim 1, further comprising, downstream of the first housing station (100) for unstacking the multilayer load (C), a second station (200) for removing the packing film (P) from single layers (S) obtained from unstacking the multilayer load (C), the second station (200) comprising:
a second housing area (201) for a layer (S) of the load (C) at least laterally enveloped by a closed annular strip (SP) of wrapping film (P);
cutting means (203), arranged adjacent to the second housing area (201) for cutting the closed annular strip (SP) such as to open the strip (SP);
automated collecting means (205) arranged adjacent to the second housing area (201) and preferably at an opposite side thereof with respect to the cutting means (203), for gripping the strip (SP) when opened and expelling the said opened strip (SP) from the second housing area (201).

9. The machine of claim 8, wherein the automated collecting means (205) comprise:
a hooking element (206) for engaging the second housing area (201), for inserting in an external peripheral profile of the annular strip (SP) of wrapping film (P) of the layer (S);
an expelling device (212) arranged externally of the second housing area (201) for intercepting the strip (SP) of wrapping film (P) and distancing the strip (SP) from the second housing area (200), preferably by sending the strip (SP) to a collecting container;
wherein the hooking element (206) is mobile between a first position, in which it is arranged in the second housing area (201) in order to insert in the external peripheral profile of the strip (SP) of wrapping material (P), and a second position, in which the hooking element (206) is located at the expeller device (212) such that in passing between the first position and the second position the hooking element (206) intercepts a portion of the strip (SP) and draws it towards the expeller device (212).

10. The machine of claim 9, wherein the hooking element (206) exhibits a prevalent development direction which is substantially perpendicular to a rest surface (202) of the second housing area (201) and is mobile with respect to the rest surface (202) between a raised position from the rest surface (202), in which it enables a layer (S) of the load (C) to be applied theron, and a lowered position towards the rest surface (202), in which it is arranged internally of the external peripheral profile of the strip (SP) of wrapping film (P) of the layer (S).

11. The machine of claim 9, wherein the expeller device (212) comprises a pair of rollers (213), at least one of which is mobile in nearing and distancing with respect to the other roller between a distanced position, suitable for passage of the hooking element (206) between the rollers (213), and a neared position, in which the rollers (213) are closed in order to grip between them a portion of the strip (SP) of film (P); at least one of the rollers (213) being motorized in order to automatically expel the strip (SP) of wrapping film (P).
